(19) United States
(12) Patent Application Publication
(10) Pub. No.: US 2019/0211203 A1
(43) Pub. Date: Jul. 11, 2019

(54) Copolyester Polymer Composition With Enhanced Elastic Properties

(71) Applicant: Celanese International Corporation, Irving, TX (US)

(72) Inventor: Denis Grechi, Ferrara (IT)

(21) Appl. No.: 16/245,754

(22) Filed: Jan. 11, 2019

Related U.S. Application Data
(60) Provisional application No. 62/616,127, filed on Jan. 11, 2018.

(51) Int. Cl. C08L 67/02; C08K 5/3412; B29D 35/12; B29D 35/14

(52) U.S. Cl. CPC C08L 67/025; C08K 5/3412; C08G 63/916; B29D 35/142; C08L 2207/04; B29D 35/122

(57) ABSTRACT

A copolyester elastomer composition is disclosed that contains a molecular weight enhancing agent that reacts with the copolyester elastomer at high temperatures. The composition of the present disclosure has excellent flow properties prior to reaction with the molecular weight increasing agent. Once an article is formed, the article can then be heated above a threshold temperature necessary for a reaction to occur between the molecular weight increasing agent and the copolyester elastomer. The reaction causes an increase in melting temperature, a decrease in hardness, and a decrease in melt volume flow rate.

### RELATED APPLICATIONS

The present application is based upon and claims priority to U.S. Provisional Application Ser. No. 62/616,127, having a filing date of Jan. 11, 2018, which is incorporated herein by reference in its entirety.

### BACKGROUND

Thermoplastic elastomers are a class of useful materials that have a unique combination of properties. The materials, for instance, can be formulated so as to be flexible and tough, while having elastic characteristics. Of particular advantage, the materials can also be melt processed due to their thermoplastic nature. Furthermore, unlike their cross-linked rubber counterparts, thermoplastic elastomers can be recycled and reprocessed.

Thermoplastic elastomers are used in numerous applications. The materials, for instance, may be molded to form a particular part or product or may comprise a component in a product. In addition, these materials may also be over-molded allowing for an additional layer to be formed on an initially molded part. Due to their flexible and elastic nature, thermoplastic elastomers are commonly used in applications where the material constantly undergoes deformation or otherwise contacts other moving parts.

One type of thermoplastic elastomers are the copolyester elastomers. Copolyester elastomers provide numerous benefits and advantages when used in certain applications due to their physical properties. Copolyester elastomers, for instance, not only have excellent flow properties but have very good elastic properties. Thermoplastic polyester elastomers, however, have relatively high hardness values making them rarely used in certain applications, such as when forming soles for footwear. Thus, footwear manufacturers typically look to other materials, such as thermoplastic polyurethane elastomers, when designing and fabricating soles for footwear, especially athletic shoes. Thermoplastic polyurethane elastomers, however, can be somewhat difficult to process and therefore can produce unacceptable amounts of scrap in certain applications.

In view of the above, a need exists for a copolyester elastomer composition capable of having a lower hardness and/or a higher melting temperature. A need also exists for a process for molding copolyester elastomer compositions into polymer articles while increasing the melting point and/or lowering the hardness of the composition.

### SUMMARY

In general, the present disclosure is directed to a copolyester elastomer composition having excellent overall physical properties, including elastic properties. Of particular advantage, the copolyester elastomer composition can be formulated so as to have a relatively low hardness value and/or an increased melting point. In this manner, the copolyester elastomer composition can be used in numerous and diverse applications. For instance, the copolyester elastomer composition can be used to produce soles for footwear. As will be explained in greater detail below, the composition can be formulated such that the composition has excellent flow properties during the molding process. During or after molding, the copolyester elastomer contained in the composition can undergo an increase in molecular weight that can lower the hardness of the composition, that can increase the melting point of the composition, and/or can decrease the tackiness of the composition.

In one embodiment, for instance, the present disclosure is directed to a copolyester elastomer composition containing a copolyester elastomer. The copolyester elastomer can include ester and ether bonds. In one particular embodiment, the copolyester elastomer can have an alternating structure defined by a multiplicity of randomly reoccurring long-chain ester units and short-chain ester units, joined together by head-to-tall chaining through ester bonds, in which the long-chain ester units are represented by the formula:

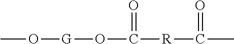

and wherein the short-chain ester units are represented by the formula:

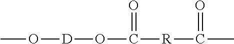

where:
G is a divalent group that remains after removal of terminal hydroxyl groups from a polyol having a molecular weight between about 250 and 6000;
R is a divalent group that remains after removal of carboxyl groups from a dicarboxylic acid having a molecular weight less than about 300;
D is a divalent group remaining after removal of hydroxyl groups from a diol having a molecular weight less than about 250,
   preferably the above alternating structure comprising from 5% to 15% by weight of short-chain ester units and from 70% to 80% by weight of long-chain ester units.

In accordance with the present disclosure, the copolyester elastomer is combined with a high temperature molecular weight increasing agent. The high temperature molecular weight increasing agent is configured to react with and increase the molecular weight of the copolyester elastomer when the composition is raised above a reaction temperature. The reaction temperature, for instance, can be greater than about 150° C., such as greater than about 155° C., such as greater than about 160° C., such as greater than about 165° C. In this manner, the composition can be molded into an article at a temperature less than the reaction temperature. The molded article can then be subsequently heated for increasing the molecular weight of the copolyester elastomer.

In one embodiment, the high temperature molecular weight increasing agent for the copolyester elastomer can comprise a capped aromatic urethane having an —NCO content of greater than about 10%, such as greater than about 12%, such as greater than about 14% by weight. For example, in one embodiment, the high temperature molecular weight increasing additive may comprise a blocked diisocyanate. The blocked diisocyanate, for instance, may have the following chemical structure:

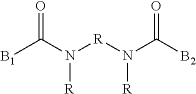

wherein R is a linear, branched or cycloaliphatic C₂-C₂₀ or aromatic C₆-C₂₀ and B₁, B₂ is a caprolactam, imidazole, dimethyl-pyrazole, triazole, oxim, malonic acid ester, ethylacetylacetonate, phenol, cresol, aliphatic alcohol, secondary amine, hydroxy benzoic acid methyl ester.

In one embodiment, the high temperature molecular weight increasing agent can be present in the composition in an amount greater than about 0.5% by weight, such as in an amount greater than about 0.7% by weight, such as in an amount greater than about 1% by weight, such as in an amount greater than about 1.5% by weight, such as in an amount greater than about 2% by weight and generally in an amount less than about 5% by weight, such as in an amount less than about 3.5% by weight, such as in an amount less than about 3% by weight.

In one embodiment, the copolyester elastomer composition can also contain one or more saturated esters. The one or more saturated esters can be present in the composition generally in an amount from about 2% to about 20% by weight. Examples of saturated esters that may be present in the composition include diethylhexyl adipate, dipropylene glycol dibenzoate, diethylene glycol dibenzoate, triethyl citrate, acetyltributylcitrate or acetyl triethyl citrate.

The copolyester elastomer composition of the present disclosure can contain various other components and ingredients. For instance, the composition can contain at least one of a lubricant, a detackifying agent and/or an antioxidant. For example, in one embodiment, the copolyester elastomer composition may contain an antioxidant comprising a phenylamine, a lubricant comprising N,N-ethylene bis stearamide, and a detackifying agent comprising a silicone gum. The detackifying agent, in one embodiment, can comprise a silicone gum combined with silica particles.

The present disclosure is also directed to molded articles formed from the copolyester elastomer composition. The article can be molded at a temperature sufficient for the copolyester elastomer to react with the high temperature molecular weight increasing agent. Various different products and parts can be made in accordance with the present disclosure. In one embodiment, for instance, the molded article may comprise a sole for a shoe.

The present disclosure is also directed to a process for molding an article. The process includes the steps of heating and molding a copolyester elastomer composition into an article. The copolyester elastomer composition can contain a copolyester elastomer in combination with a high temperature molecular weight increasing agent as described above. In one embodiment, the composition can be molded into the article at a temperature below a reaction temperature where the high temperature molecular weight increasing agent reacts with the copolyester elastomer. After the article is molded, the process can further include the step of heating the molded article to a temperature above the reaction temperature causing the high temperature molecular weight increasing agent to react with the copolyester elastomer. In this manner, the molecular weight of the copolyester elastomer can be increased after the article is molded.

For example, in one embodiment, the molded article is heated to a temperature sufficient to decrease the melt volume flow rate of the polymer composition. The melt volume flow rate measured at 190° C. and at a load of 2.16 kg, for instance, can be decreased by at least about 20%, such as by at least about 40%, such as by at least about 60%, such as by at least about 80%.

In addition, after reaction with the molecular weight increasing agent, the hardness of the polymer composition can be lowered and the melt temperature can be increased. The Shore A hardness of the polymer composition, for instance, can be less than about 85, such as less than about 80, such as less than about 75, such as less than about 70, such as less than about 65, such as less than about 60. The melting temperature, on the other hand, of the polymer composition can be greater than about 150° C., such as greater than about 155° C.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a plan view of one embodiment of a tread sole that may be made in accordance with the present disclosure;

FIG. 2 is a plan view of a midsole that may be made in accordance with the present disclosure; and

FIG. 3 is a perspective view illustrating the outsole of FIG. 1 being bonded or laminated to the midsole of FIG. 2.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a copolyester elastomer composition having enhanced physical properties. The present disclosure is also directed to a process for molding articles from the polymer composition of the present disclosure. The copolyester elastomer composition generally contains a copolyester elastomer in combination with a high temperature molecular weight increasing agent. In accordance with the present disclosure, the high temperature molecular weight increasing agent is selected such that a temperature threshold or reaction temperature is reached prior to reaction with the copolyester elastomer. In this manner, the high temperature molecular weight increasing agent can react with the copolyester elastomer prior to molding, during molding, or after the article has been molded. Through the process of the present disclosure, the flow properties of the molten polymer composition can be controlled and adjusted based on temperature. For example, in one embodiment, molded articles are formed below the reaction temperature while the polymer composition has good flow properties. After the article is formed, the temperature is then increased causing a reaction to occur between the molecular weight increasing agent and the copolyester elastomer for increasing the melting temperature of the polymer composition and reducing tackiness.

As described above, the polymer composition of the present disclosure contains a polyester elastomer and particularly a copolyester elastomer. In one embodiment, the copolyester elastomer can include ester and ether bonds. For example, the copolyester elastomer can have an alternating structure defined by a multiplicity of randomly recurring long-chain ester units and short-chain ester units, joined together by head-to-tail chaining through ester bonds.

The long-chain ester units are represented by the formula:

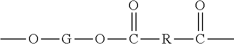

while the short-chain ester units are represented by the formula:

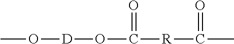

where:
G is a divalent group that remains after removal of terminal hydroxyl groups from a polyol having a molecular weight between about 250 and 6000;
R is a divalent group that remains after removal of carboxyl groups from a dicarboxylic acid having a molecular weight less than about 300;
D is a divalent group remaining after removal of hydroxyl groups from a diol having a molecular weight less than about 250.

In the case of groups G and D, the expression “divalent group” means a group having two hydroxyl reactive centres positioned one at the head and one at the tail to the molecule. In the case of group R, the expression “divalent group” means a group having two carboxyl reactive centres positioned one at the head and one in the tail to the molecule.

Structurally, the R groups are the groups that provide the polyester bond. In particular, when the R groups have an aromatic part, they confer crystallinity to the copolyester.

The G groups in combination with the R groups confer the elastomer properties to the copolyester.

The D groups in combination with the R groups confer properties of rigidity to the copolyester.

Thanks to the alternating structure defined above, it is possible to obtain a thermoplastic copolyester elastomer with high molecular weights that constitutes a not excessively hard starting basis for the polymer composition.

The above alternating structure can comprise from 5% to 15% by weight of short-chain ester units and from 70% to 80% by weight of long-chain ester units.

In one embodiment, the alternating structure thermoplastic copolyester elastomer can be obtained according to the following general reaction scheme:
esterification/transesterification of one or more dicarboxylic acids, of one or more esters of dicarboxylic acids and/or of one or more dimer or trimer carboxylic acids with diols and with diol polyglycols.
subsequent polycondensation of the products of esterification/transestenfication.

The esters of dicarboxylic acids and the dimer or trimer carboxylic acids have a molecular weight greater than 300 and the corresponding carboxylic acid has a molecular weight less than 300.

The reaction is called esterification in the case in which dicarboxylic acids are involved, while it is called transesterification when esters are involved.

In more detail, the long-chain ester units are the reaction products of the esterification/transesterification of one or more diol polyglycols selected from the following:
polytetramethylene glycols;
polypropylene glycols and their copolymers derived from ethylene oxide;
polyoxyethylene glycols;
polybutadiene glycols;
polycarbonates glycols;
diol polycaprolactones;
diols from dimer acid.

The diol polyglycols involved in the esterification/transesterification reactions for the production of long-chain ester units can be selected from the following: poly(tetramethylene ether) glycol (PTMEG); polyoxyethylene glycol (PEG); or a mixture of the two.

The short-chain ester units are the reaction products of the esterification/transesterification of one or more diols with molecular weight not greater than 250.

Advantageously, the aforesaid one or more diols involved in the esterification/transesterification reactions for the production of short-chain ester units are selected from among the aliphatic diols, can include one of the following:
monoethylene glycol;
diethylene glycol;
hexanediol;
propanediol;
1,4 butanediol; and
a mixture of two or more of them.

In one embodiment, the short-chain ester units are the reaction products of the esterification/transesterification of 1,4-butanediol.

Advantageously, in the above esterification reactions, the aforesaid one or more dicarboxylic acids are selected from the aliphatic dicarboxylic, cycloaliphatic or aromatic acids with molecular weight less than about 300.

The aforesaid one or more dicarboxylic acids can be selected from the following:
adipic acid;
mixtures of adipic acid, succinic acid and sebacic acid;
terephthalic acid;
isophthalic acid;
azelaic acid;
cyclohexanedicarboxylic acid;
naphthalene dicarboxylic acid; and
a mixture of two or more of them.

According to a particularly preferred embodiment, the aforesaid one or more dicarboxylic acids are selected from the following: terephthalic acid; isophthalic acid; or a mixture of the two.

The dicarboxylic acids can contain any substituent group or combination of substituent groups that does not interfere substantially with the formation of the polymer and with the use of the polymer in the final products.

Advantageously, in the aforesaid transesterification reactions, the aforesaid one or more esters of dicarboxylic acids are selected from the dimethyl esters of the following acids: adipic acid; mixtures of adipic acid, succinic acid and sebacic acid; terephthalic acid; isophthalic acid; azelaic acid; cyclohexanedicarboxylic acid; naphthalene dicarboxylic acid.

According to a particularly preferred embodiment, the aforesaid one or more esters of dicarboxylic acids are selected from the dimethyl esters of the following acids: terephthalic acid; isophthalic acid; or a mixture of the two.

In one embodiment, the aforesaid alternating-structure thermoplastic copolyester elastomer can be obtained by adding an esterification/transesterification catalyst to the mixture of reactants.

In particular, the aforesaid catalyst can be selected from the organic titanates, or from the complex titanates derived from alkali metal or alkaline-earth alkoxides and esters of titanic acid. Preferably, the aforesaid catalyst is titanium tetrabutylate, used alone or in combination with magnesium or calcium acetates.

The general reactive scheme in the case of transesterification of dimethyl terephthalate (DMT) with a polyglycol is provided below. In the I stage, transesterification occurs and, in the II stage, polycondensation. In the case in which the ester (DMT) is replaced by a carboxylic acid, it is called esterification, but the reactive scheme remains substantially unchanged.

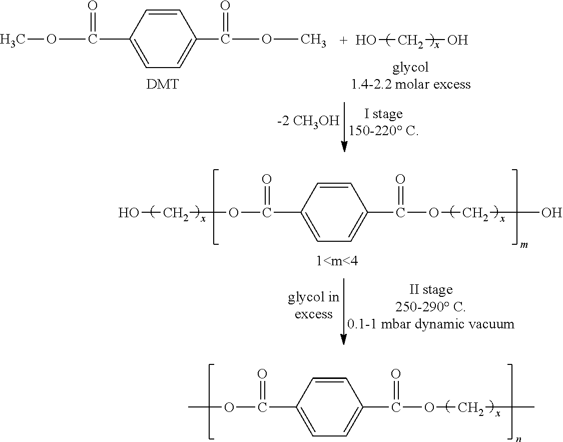

The molecular weight of the copolyester elastomer can vary depending upon the particular application. In one embodiment, for instance, the molecular weight of the copolyester elastomer is greater than about 20,000 g/mol, such as greater than about 25,000 g/mol, such as greater than about 28,000 g/mol, such as greater than about 30,000 g/mol, such as greater than about 35,000 g/mol, such as greater than about 40,000 g/mol, such as greater than about 45,000 g/mol, such as greater than about 50,000 g/mol. The molecular weight of the polyester elastomer is generally less than about 200,000 g/mol, such as less than about 100,000 g/mol.

In general, the polyester elastomer is present in the polymer composition of the present disclosure in an amount greater than about 50% by weight, such as in an amount greater than about 60% by weight, such as in an amount greater than about 70% by weight, such as in an amount greater than about 80% by weight, such as in an amount greater than about 90% by weight, such as in an amount greater than about 93% by weight. The copolyester elastomer is generally present in the polymer composition in an amount less than about 95% by weight, such as in an amount less than about 93% by weight, such as in an amount less than about 90% by weight.

In accordance with the present disclosure, the copolyester elastomer is combined with a high temperature molecular weight increasing agent. The molecular weight increasing agent reacts with the copolyester elastomer and increases the molecular weight of the polymer. In this manner, the resulting polymer composition after the above reaction has occurred has an increased melting temperature and reduced hardness. In one embodiment, the resulting polymer composition also has reduced tackiness. Through the process of the present disclosure, the polyester elastomer can be used in numerous and diverse applications that may have been unsuitable for the copolyester elastomer without addition of the molecular weight increasing agent. Merely as an example, for instance, the polymer composition of the present disclosure is particularly well suited for producing soles for footwear.

In one embodiment, the high temperature molecular weight increasing agent comprises a capped aromatic urethane. The aromatic urethane, for instance, can include various —NCO groups that are capable of reacting with the copolyester elastomer. The —NCO groups, however, can be capped and not available for reaction with the copolyester elastomer until a certain threshold temperature or reaction temperature is reached. In one embodiment, for instance, the urethane molecular weight increasing agent can have a —NCO content of greater than about 10% by weight, such as greater than about 12% by weight, such as greater than about 14% by weight. The —NCO content is generally less than about 30% by weight, such as less than about 20% by weight, such as less than about 18% by weight.

In one particular embodiment, the molecular weight increasing agent may comprise a blocked dilsocyanate. For instance, the blocked diisocyanate may have the following formula:

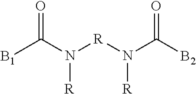

wherein R is linear, branched or cycloaliphatic C₂-C₂₀ or aromatic C₆-C₂₀ and B₁, B₂ is caprolactam, imidazole, dimethyl-pyrazole, triazole, oxim, malonic acid ester, ethylacetylacetonate, phenol, cresol, aliphatic alcohol, secondary amine, hydroxy benzoic acid methyl ester.

In one embodiment, B₁ and B₂ both comprise caprolactam. For example, in one embodiment, the molecular weight increasing agent may comprise a caprolactam blocked diisocyanate of hexamethylene diisocyanate.

In accordance with the present disclosure, the molecular weight increasing agent can comprise a blocked or capped urethane. Once a threshold or reaction temperature is reached, the blocked or capped ends of the molecular weight increasing agent can degrade, transform, or otherwise be removed from the molecular weight increasing agent allowing the molecular weight increasing agent to combine and react with the copolyester elastomer. The threshold or reaction temperature at which the blocks are removed can depend upon the molecular weight increasing agent selected for the particular composition or process. In one embodiment, for instance, the reaction temperature is greater than the melting temperature or softening temperature of the thermoplastic elastomer. In one embodiment, for instance, the reaction temperature can be greater than about 140° C., such as greater than about 145° C., such as greater than about 150° C., such as greater than about 155° C., such as greater than about 160° C., such as greater than about 165° C., such as greater than about 170° C. The reaction temperature is generally less than the temperature at which the thermoplastic elastomer degrades. In general, the reaction temperature is less than about 210° C., such as less than about 200° C., such as less than about 195° C., such as less than about 190° C., such as less than about 185° C.

The amount of molecular weight increasing agent present in the polymer composition can also depend upon various different factors. In general, the molecular weight increasing agent is present in the polymer composition in an amount greater than about 0.2% by weight, such as in an amount greater than about 0.5% by weight, such as in an amount greater than about 0.7% by weight, such as in an amount greater than about 1% by weight, such as in an amount greater than about 1.5% by weight, such as in an amount greater than about 2% by weight, such as in an amount greater than about 2.5% by weight. The molecular weight increasing agent is generally present in the polymer composition in an amount less than about 5% by weight, such as in an amount less than about 3.5% by weight, such as in an amount less than about 3% by weight.

In addition to the copolyester elastomer and the high temperature molecular weight increasing agent, the polymer composition can also contain one or more saturated esters. The one or more saturated esters can be added to the composition in order to lower the hardness of the resulting polymer. Of particular advantage, the one or more saturated esters can be added to the polymer composition for decreasing hardness without significantly increasing the viscosity of the copolyester that would interfere with the molding process.

The one or more saturated esters can generally have a low molecular weight. For instance, the molecular weight of the saturated esters can be from about 200 to about 1,000. Examples of saturated esters that may be combined with the polymer composition include the following:
diethylhexyl adipate (also known as dioctyl adipate);
dipropylene glycol dibenzoate;
diethylene glycol dibenzoate;
triethyl citrate; and
a mixture of two or more of them.

According to a particularly preferred embodiment, the aforesaid one or more saturated esters with a molecular weight between about 200 and 1,000, and preferably comprised between 300 and 380, are selected from the following:
diethyihexyl adipate;
dipropylene glycol dibenzoate;
diethylene glycol dibenzoate;
triethyl citrate;
acetyltributylcitrate;
acetyl triethyl citrate and
a mixture of two or more of them.

Operationally, the aforesaid one or more saturated esters can be added to the molten thermoplastic copolyester elastomer at the end of the polycondensation reaction or to the solid granulated thermoplastic copolyester elastomer, in the drying and curing step.

In more detail, in the case of addition to the molten polymer, once the polycondensation reaction ended, the saturated esters are added directly into the reactor (with batch technology) or at the exit of the reactor through the use of a static mixer.

In the case of addition to the finished polymer, the saturated esters are added to the copolyester in a rotational mixer heated by a diathermic oil circuit that increases the temperature of the polymer up to 100° C. After the addition of the saturated esters, the mass is left at this temperature for a period ranging from 8 to 24 hours. Subsequently, the mass is cooled and discharged.

When present, one or more saturated esters can generally be added to the polymer composition in an amount greater than about 2% by weight, such as in an amount greater than about 5% by weight, such as in an amount greater than about 8% by weight, such as in an amount greater than about 10% by weight, such as in an amount greater than about 12% by weight, such as in an amount greater than about 15% by weight. The one or more saturated esters are generally present in the polymer composition in an amount less than about 20% by weight, such as in an amount less than about 18% by weight, such as in an amount less than about 16% by weight.

In addition to one or more saturated esters, the polymer composition of the present disclosure can also contain various other components designed to decrease tackiness and/or decrease hardness. In one embodiment, for instance, the polymer composition can contain a detackifying agent. For example, in one embodiment, the detackifying agent may comprise a high-viscosity silicone gum. In one embodiment, the silicone gum can be combined with silica particles. For instance, the silica particles can be present in the detackifying agent in an amount from about 20% to about 40% by weight. The detackifying agent can reduce the tackiness of the resulting polymer composition and, in one embodiment, can also reduce hardness. When present, the tackifying agent can be added to the polymer composition in an amount generally greater than about 0.5% by weight, such as in an amount greater than about 1% by weight, such as in an amount greater than about 2% by weight, and generally in an amount less than about 10% by weight, such as in an amount less than about 8% by weight, such as in an amount less than about 5% by weight, such as in an amount less than about 4% by weight.

In addition to the above components, the polymer composition may include various other ingredients. Colorants that may be used include any desired inorganic pigments, such as titanium dioxide, ultramarine blue, cobalt blue, and other organic pigments and dyes, such as phthalocyanines, anthraquinones, Holcomax black 69969 and the like. Other colorants include carbon black or various other polymer-soluble dyes. The colorants can generally be present in the composition in an amount up to about 5 percent by weight.

Antioxidants that may be present in the composition include sterically hindered phenol compounds. The antioxidants may provide thermal stability during and after molding and/or any secondary processing. Examples of such compounds, which are available commercially, are pentaerythritol tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate](Irganox 259, BASF), 3,5-di-tert-butyl-4-hydroxytoluene (Lowinox BHT, Chemtura) and n-octadecyl-β-(4-hydroxy-3,5-di-tert-butyl-phenyl)propionate. In one embodiment, for instance, the antioxidant comprises tetrakis[methylene(3,5-di-tert-butyl-4-hydroxyhydrocinnamate)]methane. In an alternative embodiment, the antioxidant may comprise beta-laurylthiopropionate.

In addition to hindered phenol compounds, in one embodiment, the antioxidant may comprise an aromatic amine. For instance, in one embodiment, the antioxidant may comprise a phenylamine, such as a diphenylamine. In one embodiment, for instance, the antioxidant may comprise 4,4′-bis(α,α-dimethylbenzyl) diphenylamine. The antioxidant may be present in the composition in an amount less than 2% by weight, such as in an amount from about 0.1 to about 1.5% by weight.

Light stabilizers that may be present in the composition include sterically hindered amines. Such compounds include 2,2,6,6-tetramethyl-4-piperidyl compounds, e.g., bis(2,2,6,6-tetramethyl-4-piperidyl) sebacate (Tinuvin 770, BASF) or the polymer of dimethyl succinate and 1-(2-hydroxyethyl)-4-hydroxy-2,2,6,6-tetramethyl-4-piperidine (Tinuvin 622, BASF). UV absorbers that may be present in the composition include benzophenones or benzotriazoles. Any suitable benzophenone or benzotriazole may be used in accordance with the present disclosure. The light stabilizer and UV absorber may improve weatherability and may be present in an amount from about 0.1% to about 3% by weight, such as from about 0.5% to about 1.5% by weight.

In one embodiment, the polymer composition may contain a blend of a light stabilizer and a UV absorber. The blend may also provide ultraviolet light resistance and color stability that prevents color fading. In one embodiment, the polymer composition may contain a combination of a benzotriazole or benzophenone UV absorber and a hindered amine light stabilizer such as an oligomeric hindered amine.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm.

In one embodiment, a nucleating agent may be present in the composition. The nucleating agent may comprise a particulate filler, such as a mineral filler. Nucleating agents include talc, clay, silica, calcium silicate, mica, calcium carbonate, titanium dioxide, and the like. The nucleating agent may be present in the composition in an amount from about 0.5% to about 50% by weight, such as from about 0.5% to about 15% by weight.

Various other stabilizers may also be present in the composition. For instance, in one embodiment, the composition may contain a phosphite, such as a diphosphite. For instance, in one embodiment, the phosphite compound may comprise a pentaerythritol phosphite, a pentaerythritol diphosphite, or a distearyl pentaerythritol diphosphite. The phosphite compound may also comprise bis(2,4-ditert-butylphenyl)pentaerythritol diphosphite. The phosphite compound may also comprise O,O′-Dioctadecylpentaerythritol bis(phosphite). An organophosphite processing stabilizer as described above may be present in the polymer composition in an amount less than about 2% by weight, such as in an amount from about 0.1% to about 1.5% by weight.

In one embodiment, the polymer composition may also contain a lubricant, such as an external lubricant. For example, the lubricant may comprise an amide wax. Amide waxes may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form N,N-ethylene bis stearamide wax. Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl)12-hydroxystearamide and N,N′-(ethylene bis)12-hydroxystearamide. Other suitable fatty acid amides include erucamide wax and bisdodecanamide. The above fatty acid amides may be used alone or in combination. For example a commercially available blend of fatty acid amides includes EBO 44%, ER 33%, oleyl palmitamide (vegetable source secondary amide) 22% which can be obtained as a commercially available blend. One or more lubricants can generally be present in the polymer composition in an amount greater than about 0.1% by weight, such as in an amount greater than about 0.2% by weight and generally in an amount less than about 5% by weight, such as in an amount less than about 3% by weight, such as in an amount less than about 1% by weight.

In one embodiment, the polymer composition can also contain an expanding additive. The expanding additive may comprise, for instance, a physical expanding agent or a chemical expanding agent. Physical expanding agents may comprise, for instance, microspheres containing a swelling agent. Chemical expanding agents, on the other hand, can comprise gas-releasing type agents such as sodium bicarbonate and/or citric acid. In one embodiment, the composition may contain both a physical expanding agent and a chemical expanding agent. Expanding agents can generally be added to the composition in an amount greater than about 1% by weight, such as in an amount greater than about 2% by weight, such as in an amount greater than about 3% by weight, such as in an amount greater than about 4% by weight, such as in an amount greater than about 5% by weight and generally in an amount less than about 10% by weight, such as in an amount less than about 8% by weight.

In order to produce molded articles in accordance with the present disclosure, the different components of the polymer composition can be dry blended together in a drum tumbler or in a high intensity mixer. The premixed blends can then be melt blended and extruded as pellets. The pellets can then be used in an injection molding process, or extrusion process. The composition can also be process to form films such as cast films or blown films.

In one embodiment, the above pellets can be formed at a temperature less than the reaction temperature of the molecular weight increasing agent. In this manner, the pellets can contain the copolyester elastomer and the molecular weight increasing agent in a substantially unreacted state. The polymer composition can retain a relatively high melt flow rate and therefore can be easily melt processed and formed into various articles.

During the formation of polymer articles in accordance with the present disclosure, the temperature can be raised above the reaction temperature of the molecular weight increasing agent. For instance, the polymer composition can be subjected to a temperature above the reaction temperature during molding or after the molded article has been formed. For example, in one embodiment, molding of the polymer article can generally occur at a temperature of less than about 150° C., such as less than about 140° C., such as less than about 130° C., and generally greater than about 100° C., such as greater than about 110° C. More particularly, the polymer composition can be heated to a temperature sufficient for the composition to assume a molten state but to a temperature insufficient to cause a reaction to occur between the molecular weight increasing agent and the copolyester elastomer. A polymer article can then be formed through any suitable process, such as through injection molding. After the polymer article is formed, the polymer article can be subjected to higher temperatures that cause a reaction to occur between the molecular weight increasing agent and the copolyester elastomer. For example, the polymer article can be heated above the reaction temperature, such as above about 150° C., such as above about 160° C., such as above about 165° C., such as above about 170° C., such as above about 175° C., such as above about 180° C., and generally to a temperature of less than about 220° C., such as to a temperature of less than about 200° C.

Through the process of the present disclosure, the polymer article is molded while the polymer composition has excellent flow properties. After the article is molded, however, the polymer composition is subjected to a heat treatment that causes the molecular weight of the copolyester elastomer to increase. Increasing the molecular weight of the copolyester elastomer also increases the melting point of the polymer composition, can decrease the hardness of the polymer composition, and can decrease the melt volume flow rate.

In one embodiment, for instance, after the copolyester elastomer has reacted with the molecular weight increasing agent, the resulting polymer composition can have a melting temperature of greater than about 150° C., such as greater than about 153° C., such as greater than about 155° C. The melting temperature is generally less than about 200° C., such as less than about 180° C., such as less than about 170° C. After reaction with the molecular weight increasing agent, the melt volume flow rate of the polymer composition when measured at 190° C. and at a load of 2.16 kg (ISO Test 1133) can decrease by at least about 20%, such as by at least about 40%, such as by at least about 60%, such as by at least about 80%. For example, the melt volume flow rate of the reacted polymer composition can be less than about 8 cm³/10 min, such as less than about 6 cm³/10 min, such as less than about 4 cm³/10 min, such as less than about 2 cm³/10 min. The melt volume flow rate is generally greater than about 0.1 cm³/10 min, such as greater than about 0.5 cm³/10 min. The melt volume flow rate can also be tested at 220° C., depending on the composition.

In addition to the melt volume flow rate, the hardness of the polymer composition may also decrease. For instance, the Shore A hardness of the polymer composition after reaction can be less than about 90, such as less than about 85, such as less than about 80, such as less than about 75, such as less than about 70. The Shore A hardness is generally greater than about 50, such as greater than about 60, such as greater than about 65.

Various different articles and parts can be made in accordance with the present disclosure. For instance, the copolyester elastomer composition is particularly well suited to producing automotive parts, consumer appliance parts, and the like. In one embodiment, for instance, the copolyester elastomer composition of the present disclosure can be used to produce soles for footwear.

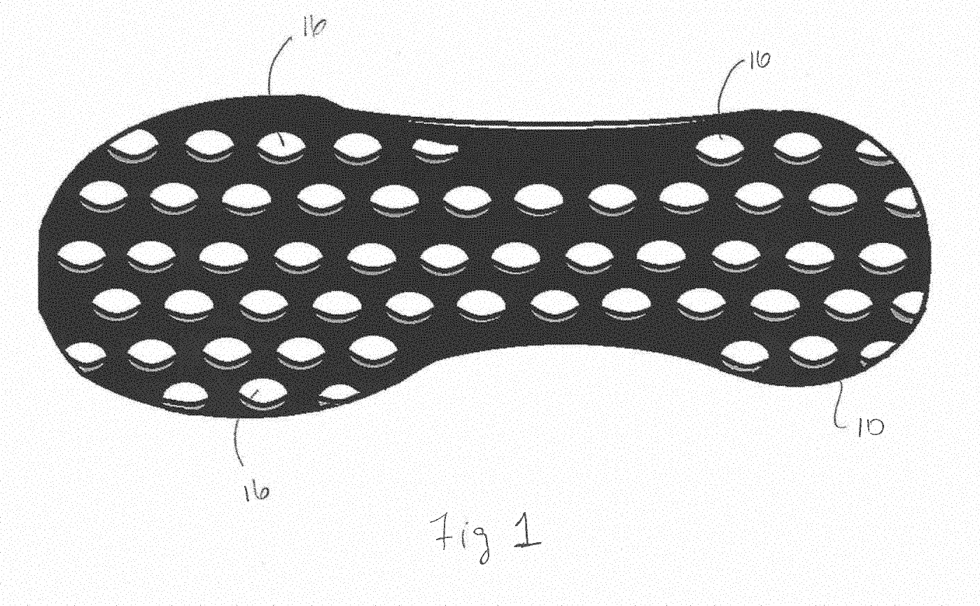

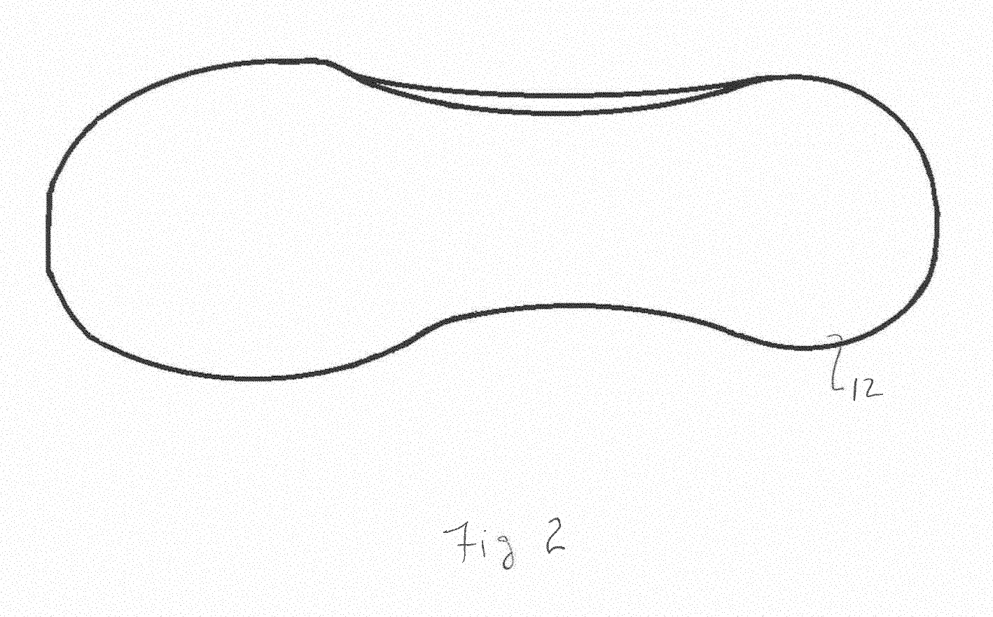

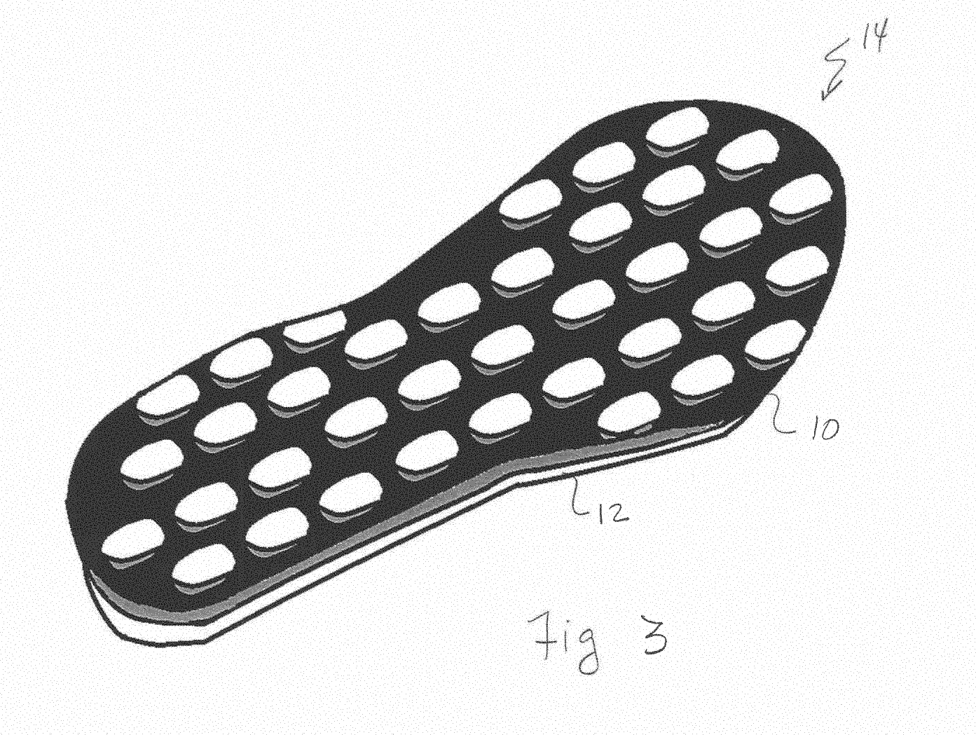

Referring to FIGS. 1-3, for instance, one embodiment of a shoe sole made in accordance with the present disclosure is illustrated. FIG. 1, for instance, illustrates a tread sole or outsole 10. FIG. 2, on the other hand, illustrates a midsole 12. In FIG. 3, the midsole 12 is laminated to the outsole 10 to form the sole 14. The sole 14 may be used in all different types of shoes, such as a sports shoe or athletic shoe. The midsole 12 as shown in FIG. 2 is designed to provide cushioning support to the foot of a wearer. The outsole or tread sole 10, on the other hand, is for providing traction when the footwear is wom. The outsole 10 and the midsole 12 can be attached together as shown in FIG. 3 in order to complement each other. In accordance with the present disclosure, the outsole 10 and the midsole 12 can be made from the copolyester elastomer composition of the present disclosure. In an alternative embodiment, either the outsole 10 or the midsole 12 can be made from the polymer composition. When using the polymer composition of the present disclosure to produce the midsole 12, the midsole 12 can include an expansion agent alone or in combination with a reinforcing element.

In one embodiment as shown in FIGS. 1 and 2, the outsole 10 can include a plurality of openings 16. When laminated to the midsole 12, the midsole can be exposed to the outside environment through the openings 16.

In one embodiment, the tread sole or outsole 10 can be molded from the elastomeric composition of the present disclosure prior to the midsole 12. The midsole 12, on the other hand, can be compression molded. In one embodiment, the midsole 12 can be compression molded at the same time the tread sole 10 is attached to the midsole. For example, in one embodiment, the tread sole 10 can be formed at a temperature below the reaction temperature of the molecular weight increasing agent. The tread sole 10 can then be attached to the midsole 12 during compression molding at a temperature above the reaction temperature. In this manner, the tread sole 10 attaches to the midsole 12 at the same time the molecular weight increasing agent reacts with the copolyester elastomer. The step of laminating the tread sole 10 to the midsole 12 to form the sole 14 as shown in FIG. 3 can occur at a temperature of generally greater than about 160° C., such as at a temperature of greater than about 165° C., such as at a temperature of greater than about 170° C., and generally at a temperature of less than about 200° C.

The present disclosure may be better understood with reference to the following example.

### Example

The following copolyester composition was formulated in accordance with the present disclosure and tested for physical properties.

| Component | Weight % |
|---|---|
| Copolyester elastomer | 77.7 |
| Dioctyl adipate | 13.7 |
| Black pigment master batch | 2 |
| Caprolactam blocked diisocyanate | 2.5 |
| (—NCO 16-17% by weight) | |
| N,N-ethylene bis stearamide | 0.3 |
| 4,4′-bis(α,α-dimethylbenzyl) diphenylamine | 0.8 |
| Silicone gum containing 30% by weight | 3 |
| fumed silica | |

The above formulation was molded into plaques at different temperatures. The melt volume flow rate was then measured after molding.

| | MVR 190° C./2.16 kg |
|---|---|
| Virgin copolyester elastomer | >50 |
| Molded 160° C. | 10.2 |
| Molded 180° C. | 1.2 |
| Molded 200° C. | 5.8 |

As shown above, at a temperature greater than about 160° C., the molecular weight increasing agent reacted with the copolyester elastomer and increased the melt flow rate.

The polymer composition molded at 180° C. was then tested for various physical properties. The following results were obtained:

| | |
|---|---|
| Hardness Shore A, 15s (—) | 75 |
| Tear Strength (ISO 34C) | 86.3 |
| Melt Volume Rate 190° C./2.16 kg (cc/10 min) | 1.2 |
| Density (g/cm³) | 1.055 |
| Melting Temp. (° C.) | 156 |
| Cryst. Point (° C.) | 115 |
| Tensile Strength (ISO 527//) (MPa) | 24.8 |
| Elongation at Break // (ISO 527) (%) | 915 |
| Flexural Modulus (ISO 178) (MPa) | 38 |
| Abrasion Resistance (DIN 535) (mm³) | 25 |

Of particular advantage, the above properties are very similar to thermoplastic polyurethane polymers used in the past.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A copolyester elastomer composition comprising:
a copolyester elastomer, the copolyester elastomer including ester and ether bonds;
at least one of a lubricant, a detackifying agent, or an antioxidant; and
a high temperature molecular weight increasing agent for the copolyester elastomer, the high temperature molecular weight increasing agent reacting with and increasing the molecular weight of the copolyester elastomer at temperatures greater than about 150° C.

2. A copolyester elastomer composition as defined in claim 1, wherein the high temperature molecular weight increasing agent comprises a capped aromatic urethane having an —NCO content of greater than about 10% by weight.

3. A copolyester elastomer composition as defined in claim 1, wherein the high temperature molecular weight increasing agent comprises a blocked diisocyanate.

4. A copolyester elastomer composition as defined in claim 3, wherein the blocked diisocyanate has the following chemical structure: 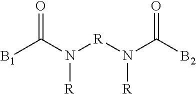
wherein R comprises a linear, branched or cycloaliphatic C₂-C₂₀ or aromatic C₆-C₂₀ and B₁, B₂ independently comprises caprolactam, imidazole, dimethyl-pyrazole, triazole, oxim, malonic acid ester, ethylacetylacetonate, phenol, cresol, aliphatic alcohol, secondary amine, or hydroxy benzoic acid methyl ester.

5. A copolyester elastomer composition as defined in claim 4, wherein B₁ and B₂ comprise caprolactam.

6. A copolyester elastomer composition as defined in claim 1, wherein the high temperature molecular weight increasing agent is present in the composition in an amount from about 0.5% to about 5% by weight.

7. A copolyester elastomer composition as defined in claim 1, wherein the composition contains the lubricant, the detackifying agent, and the antioxidant.

8. A copolyester elastomer composition as defined in claim 7, wherein the lubricant comprises N,N-ethylene bis stearamide, the detackifying agent comprises a silicone gum, and the antioxidant comprises a phenylamine.

9. A copolyester elastomer composition as defined in claim 8, wherein the detackifying agent further contains silica particles.

10. A copolyester elastomer composition as defined in claim 1, wherein the composition further contains one or more saturated esters.

11. A copolyester elastomer composition as defined in claim 10, wherein the one or more saturated esters are present in the composition in an amount from about 2% to about 20% by weight.

12. A copolyester elastomer composition as defined in claim 10, wherein the one or more saturated esters comprise diethylhexyl adipate, dipropylene glycol dibenzoate, diethylene glycol dibenzoate, triethyl citrate, acetyltributylcitrate or acetyl triethyl citrate.

13. A copolyester elastomer composition as defined in claim 1, wherein said thermoplastic copolyester elastomer has an alternating structure defined by a multiplicity of randomly recurring long-chain ester units and short-chain ester units, joined together by head-to-tail chaining through ester bonds, in which the long-chain ester units are represented by the formula: 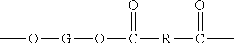
and wherein the short-chain ester units are represented by the formula: 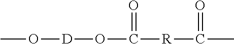
where:
G is a divalent group that remains after removal of terminal hydroxyl groups from a polyol having a molecular weight between about 250 and 6000;
R is a divalent group that remains after removal of carboxyl groups from a dicarboxylic acid having a molecular weight less than about 300;
D is a divalent group remaining after removal of hydroxyl groups from a diol having a molecular weight less than about 250, the above alternating structure comprising from 5% to 15% by weight of short-chain ester units and from 70% to 80% by weight of long-chain ester units.

14. A molded article formed from the copolyester elastomer composition as defined in claim 1, wherein the article has been molded at a temperature sufficient for the copolyester elastomer to react with the high temperature molecular weight increasing agent.

15. A molded article as defined in claim 14, wherein the article comprises a sole for a shoe.

16. A molded article as defined in claim 14, wherein a molecular weight of the copolyester elastomer has been increased by reacting with the high temperature molecular weight increasing agent such that the melt volume rate of the composition has increased by at least about 20% when tested at 190° C. and at a load of 2.16 kg.

17. A molded article as defined in claim 14, wherein the polymer composition after molding has a Shore A hardness of from about 60 to about 85 and has a melting temperature greater than about 150° C.

18. A process for molding an article comprising:
heating and molding a copolyester elastomer composition into an article, the copolyester elastomer composition comprising a copolyester elastomer combined with a high temperature molecular weight increasing agent for the copolyester elastomer, the high temperature molecular weight Increasing agent reacting with the copolyester elastomer at a reaction temperature and wherein the article is molded at a temperature less than the reaction temperature; and
heating the molded article above the reaction temperature causing the high temperature molecular weight increasing agent to react with the copolyester elastomer.

19. A process as defined in claim 18, wherein the copolyester elastomer composition further contains one or more saturated esters.

20. A process as defined in claim 19, wherein the one or more saturated esters comprise diethylhexyl adipate, dipropylene glycol dibenzoate, diethylene glycol dibenzoate, triethyl citrate, acetyltributylcitrate or acetyl triethyl citrate.

21. A process as defined in claim 18, wherein the high temperature molecular weight Increasing agent comprises a capped aromatic urethane having an —NCO content of greater than about 10% by weight.

22. A process as defined in claim 21, wherein the high temperature molecular weight increasing agent comprises a blocked diisocyanate.

23. A process as defined in claim 22, wherein the blocked diisocyanate has the following chemical structure: 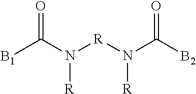
wherein R comprises a linear, branched or cycloaliphatic C₂-C₂₀ or aromatic C₆-C₂₀ and B₁, B₂ independently comprises caprolactam, imidazole, dimethyl-pyrazole, triazole, oxim, malonic acid ester, ethylacetylacetonate, phenol, cresol, aliphatic alcohol, secondary amine, or hydroxy benzoic acid methyl ester.

24. A process as defined in claim 18, wherein a molecular weight of the copolyester elastomer has been Increased by reacting with the high temperature molecular weight increasing agent such that the melt volume rate of the composition has increased by at least about 20% when tested at 190° C. and at a load of 2.16 kg.

25. A process as defined in claim 18, wherein the polymer composition after molding has a Shore A hardness of from about 60 to about 85 and has a melting temperature greater than about 150° C.
